(19) United States
(12) Patent Application Publication
(10) Pub. No.: US 2026/0335177 A1
(43) Pub. Date: Oct. 29, 2026

(54) Hollowed-Out Massager

(71) Applicant: Dongguan Yishuo Electronic Technology Co., Ltd., Dongguan (CN)

(72) Inventor: Quan Zhao, Dongguan (CN)

(21) Appl. No.: 19/284,662

(22) Filed: Jul. 29, 2025

Related U.S. Application Data
(63) Continuation-in-part of application No. 19/193,066, filed on Apr. 29, 2025, now Pat. No. 12,491,130.

(30) Foreign Application Priority Data
Apr. 25, 2025 (CN) 202520801775.2

(51) Int. Cl. A61H 19/00

(52) U.S. Cl. CPC A61H 19/00

(57) ABSTRACT

A hollowed-out massager, comprising a silicone handle, wherein an interior of the silicone handle encloses a plastic handle right shell and a plastic handle left shell, and a silicone body is provided on a right side of the plastic handle right shell and plastic handle left shell; a 130 gearbox motor is provided inside the plastic handle right shell, plastic handle left shell, and silicone body. By providing the 130 gearbox motor, eccentric rod shaft, rocking member, and fixing member inside the plastic handle right shell, plastic handle left shell, and silicone body, operation of the 130 gearbox motor drives the eccentric rod shaft to rotate. Rotation of the eccentric rod shaft drives the fixing member and rocking member to rotate. Due to the eccentric setting of the eccentric rod shaft, during the rotation of the rocking member, the rotational effect is transformed into a tapping effect.

### TECHNICAL FIELD

The invention relates to the technical field of massagers, and in particular to a hollowed-out massager.

### BACKGROUND ART

Massagers primarily function by simulating or enhancing sexual stimulation to help users achieve sexual satisfaction, relieve sexual stress, or assist in resolving sexual function-related issues. However, existing massagers have relatively singular functions and cannot provide users with a multi-dimensional massage experience. To address this, we propose a hollowed-out massager.

### SUMMARY OF THE INVENTION

The objective of the invention is to provide a hollowed-out massager to solve the problems mentioned hereinabove.

In order to solve the above objective, the invention provides the following technical solution: a hollowed-out massager, comprising a silicone handle, wherein an interior of the silicone handle encloses a plastic handle right shell and a plastic handle left shell, and a silicone body is provided on a right side of the plastic handle right shell and plastic handle left shell; a 130 gearbox motor is provided inside the plastic handle right shell, plastic handle left shell, and silicone body, and a right side of the 130 gearbox motor is provided with an end cover; an output end of the 130 gearbox motor penetrates through the end cover and extends rightward, and is fixedly connected to an eccentric rod shaft; a rocking member is externally provided on a right side of the eccentric rod shaft, and a fixing member is fixedly connected to a right end of the eccentric rod shaft; the eccentric rod shaft, the fixing member, and the rocking member all rotate inside the silicone body.

The silicone body is hollowed-out in an up-down direction; a shape of a hollowed-out groove is one of polygon, ellipse, circle, rectangle, square, and gourd shape, including but not limited to; or a combination of at least any two of polygon, ellipse, circle, rectangle, square, and gourd shape.

The silicone body is hollowed-out in a left-right direction; a shape of a hollowed-out groove is one of polygon, ellipse, circle, rectangle, square, and gourd shape, including but not limited to; or a combination of at least any two of polygon, ellipse, circle, rectangle, square, and gourd shape.

The silicone body is hollowed-out in up-down and left-right directions; a shape of a hollowed-out groove is one of polygon, ellipse, circle, rectangle, square, and gourd shape, including but not limited to; or a combination of at least any two of polygon, ellipse, circle, rectangle, square, and gourd shape.

A silicone head is provided on a right side of the silicone body, a 030 motor shell is provided inside the silicone head, and a 030 vibration motor is provided inside the 030 motor shell.

An upper inner side of the plastic handle right shell and plastic handle left shell encloses an N20 gearbox motor; an output end of the N20 gearbox motor is fixedly connected to an eccentric wheel, and another end of the eccentric wheel is fixedly connected to a hollow rod; another end of the hollow rod is rotatably connected to an M20 finger lower shell, and a right side of the M20 finger lower shell is provided with an M20 finger upper shell; an M20 vibration motor is provided inside the M20 finger lower shell and M20 finger upper shell.

Cooperative use between the 130 gearbox motor, 030 vibration motor, N20 gearbox motor, M20 vibration motor, clamping structure, rocking member, and other structures enables conversion of rotational motion into clamping and rocking motions, achieving tapping, rocking, and vibration effects; clamping, rocking, and vibration can be controlled separately or work jointly via a PCBA board.

A left inner side of the plastic handle right shell and plastic handle left shell is provided with a PCBA board, a top of which is connected to a silicone button; a transparent cover is provided on a top of the silicone button, and a digital display light shield is provided on a top right side of the PCBA board.

A lower left corner inside the plastic handle right shell and plastic handle left shell is provided with a battery and a magnetic charging pin board assembly that are electrically connected.

A bilateral clamping assembly is installed at an inner top end of a silicone cover; an output end of a motor 18 is fixedly connected to a rotating block, a top side of the rotating block is fixedly connected to a hollow rod, and the hollow rod is fixedly connected to a swinging member; a pushing block is fixedly connected to a motor shell, and a motor 13 is installed inside the motor shell.

The invention has at least the following beneficial effects.

By providing the 130 gearbox motor, eccentric rod shaft, rocking member, and fixing member inside the plastic handle right shell, plastic handle left shell, and silicone body, operation of the 130 gearbox motor drives the eccentric rod shaft to rotate. Rotation of the eccentric rod shaft drives the fixing member and rocking member to rotate. Due to the eccentric setting of the eccentric rod shaft, during the rotation of the rocking member, the rotational effect is transformed into a tapping effect. Simultaneously, the hollowed-out design of the silicone body enhances the user experience, improves the effect of stimulating sensitive points, and provides better transmission efficiency.

### BRIEF DESCRIPTION OF ACCOMPANY DRAWINGS

FIG. 1 is a side view of the structure according to the invention;

FIG. 2 is a top view of the structure according to the invention;

FIG. 3 is a first schematic diagram of the internal structure according to the invention;

FIG. 4 is a cross-sectional view of the internal structure according to the invention;

FIG. 5 is a schematic diagram of the tapping function according to the invention;

FIG. 6 is a schematic diagram of the clamping function according to the invention;

FIG. 7 is a second schematic diagram of the internal structure according to the invention;

FIG. 8 is a left-right hollowed-out polygon diagram according to the invention;

FIG. 9 is a left-right hollowed-out ellipse diagram according to the invention;

FIG. 10 is a left-right hollowed-out circle diagram according to the invention;

FIG. 11 is a left-right hollowed-out rectangle diagram according to the invention;

FIG. 12 is a left-right hollowed-out square diagram according to the invention;

FIG. 13 is a left-right hollowed-out gourd shape diagram according to the invention;

FIG. 14 is an up-down-left-right hollowed-out polygon diagram according to the invention;

FIG. 15 is an up-down-left-right hollowed-out ellipse diagram according to the invention;

FIG. 16 is an up-down-left-right hollowed-out circle diagram according to the invention;

FIG. 17 is an up-down-left-right hollowed-out rectangle diagram according to the invention;

FIG. 18 is an up-down-left-right hollowed-out square diagram according to the invention;

FIG. 19 is an up-down-left-right hollowed-out gourd shape diagram according to the invention;

FIG. 20 is a first exploded view of the overall structure according to the invention;

FIG. 21 is a second exploded view of the overall structure according to the invention;

FIG. 22 is an overall structural diagram of Embodiment 3 according to the invention.

In the figures: 1 refers to the silicon handle; 2 refers to the silicon body; 3 refers to the silicon head; 4 refers to the transparent cover; 5 refers to the battery; 6 refers to the magnetic charging pin board assembly; 7 refers to the 130 gearbox motor; 8 refers to the M20 finger upper shell; 9 refers to the 030 vibration motor; 10 refers to the 030 motor shell; 11 refers to the end cover; 12 refers to the eccentric rod shaft; 13 refers to the fixing member; 14 refers to the rocking member; 15 refers to the N20 gearbox motor; 16 refers to the hollow rod; 17 refers to the M20 finger lower shell; 18 refers to the M20 gearbox motor; 19 refers to the eccentric wheel; 20 refers to the silicon button; 21 refers to the PCBA board; 22 refers to the digital display light shield; 23 refers to the plastic handle right shell; 24 refers to the plastic handle left shell; 201 refers to the hollowed-out groove; 31 refers to the YS101 decorative cover; 32 refers to the YS101 silicon button; 33 refers to the battery (801730) 450 MAH; 34 refers to the YS101-PCBA main board; 35 refers to the magnetic charging pin assembly; 36 refers to the YS101 plastic upper shell; 37 refers to the YS101 double-layer eccentric wheel; 38 refers to the first YS101 pushing block; 39 refers to the first YS101 clamping leaf; 310 refers to the swinging N10 lower shell; 311 refers to the N10 motor upper cover; 312 refers to the YS101 silicone cover; 313 refers to the N10 copper head motor; 314 refers to the second YS101 clamping leaf; 315 refers to the second YS101 pushing block; 316 refers to the hollow rod/POM; 317 refers to the YS101 plastic lower shell; 318 refers to the N30 gearbox motor.

### SPECIFIC EMBODIMENT OF THE INVENTION

The technical solutions in the embodiments of the invention will be clearly and completely described hereinafter with reference to the drawings in the embodiments of the invention. Obviously, the described embodiments are only a part of the embodiments of the invention, rather than all the embodiments. Based on the embodiments of the invention, all other embodiments obtained by those of ordinary skill in the art without creative efforts shall fall within the protection scope of the invention.

### Embodiment 1

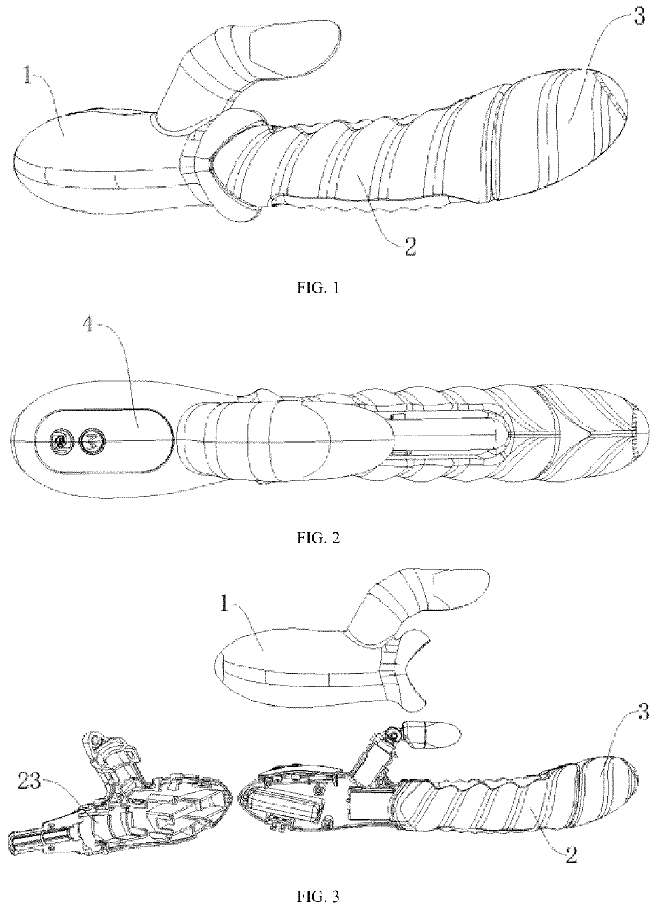

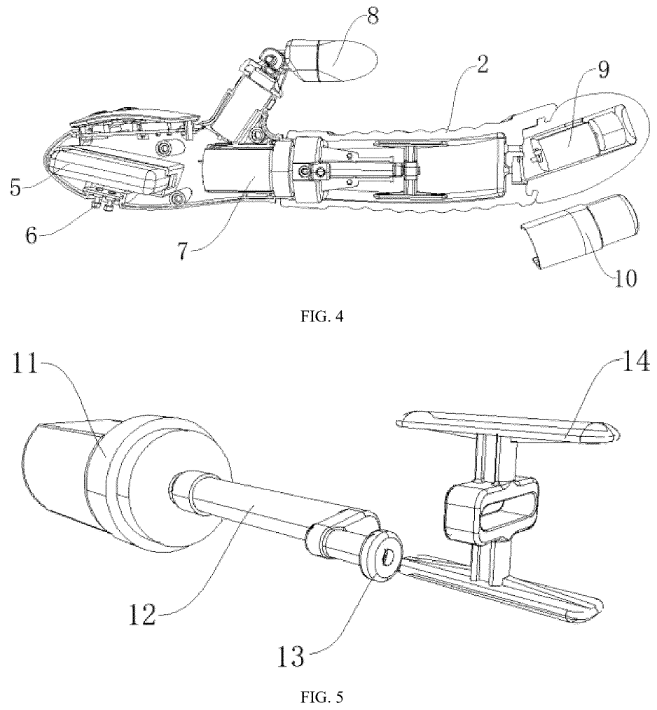

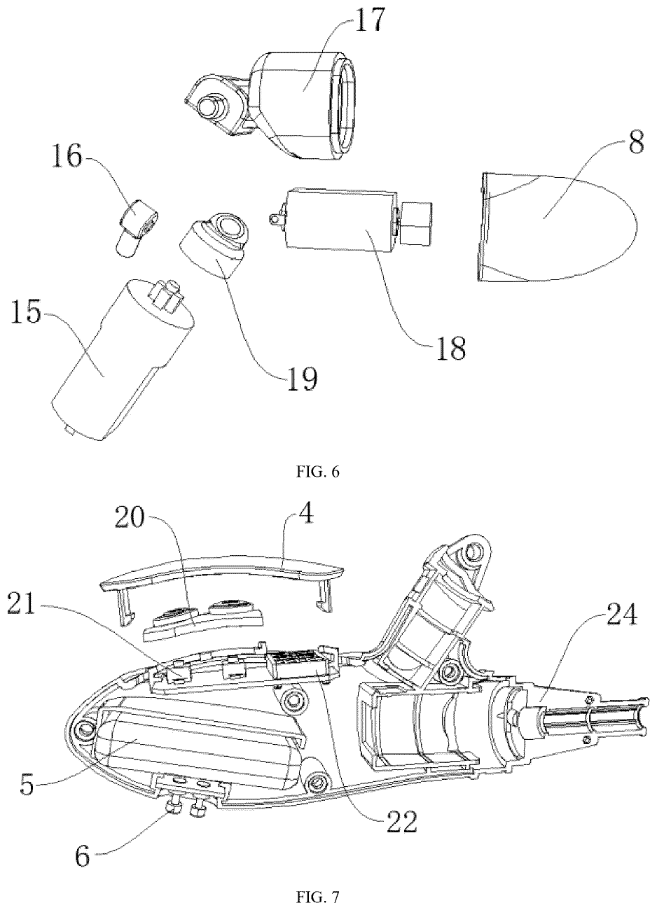

With reference to FIGS. 1-7, the invention provides a technical solution: a hollowed-out massager, comprising a silicone handle 1, wherein an interior of the silicone handle 1 encloses a plastic handle right shell 23 and a plastic handle left shell 24, and a silicone body 2 is provided on a right side of the plastic handle right shell 23 and plastic handle left shell 24; a 130 gearbox motor 7 is provided inside the plastic handle right shell 23, plastic handle left shell 24, and silicone body 2, and a right side of the 130 gearbox motor 7 is provided with an end cover 11; an output end of the 130 gearbox motor 7 penetrates through the end cover 11 and extends rightward, and is fixedly connected to an eccentric rod shaft 12; a rocking member 14 is externally provided on a right side of the eccentric rod shaft 12, and a fixing member 13 is fixedly connected to a right end of the eccentric rod shaft 12; the eccentric rod shaft 12, the fixing member 13, and the rocking member 14 all rotate inside the silicone body 2.

By arranging the 130 gearbox motor 7, eccentric rod shaft 12, rocking member 14, and fixing member 13 inside the plastic handle right shell 23, plastic handle left shell 24, and silicone body 2, operation of the 130 gearbox motor 7 drives rotation of the eccentric rod shaft 12. This rotation transmits motion to the fixing member 13 and rocking member 14. Due to the eccentric configuration of the eccentric rod shaft 12, the rotational motion is converted into a tapping effect during actuation of the rocking member 14. Concurrently, the hollowed-out design of the silicone body 2 enhances user experience by improving contact with sensitive areas and optimizing force transmission efficiency.

A silicone head 3 is provided on a right side of the silicone body 2, a 030 motor shell 10 is provided inside the silicone head 3, and an 030 vibration motor 9 is provided inside the 030 motor shell 10. Activation of this motor generates vibratory stimulation at the massager's distal end

An upper inner side of the plastic handle right shell 23 and plastic handle left shell 24 encloses an N20 gearbox motor 15; an output end of the N20 gearbox motor 15 is fixedly connected to an eccentric wheel 19, and another end of the eccentric wheel 19 is fixedly connected to a hollow rod 16; another end of the hollow rod 16 is rotatably connected to an M20 finger lower shell 17, and a right side of the M20 finger lower shell 17 is provided with an M20 finger upper shell 8; an M20 vibration motor 18 is provided inside the M20 finger lower shell 17 and M20 finger upper shell 8. When the N20 gearbox motor 15 operates, it drives the eccentric wheel 19 and hollow rod 16 to rotate, and the eccentric wheel 19 is used to drive the M20 finger lower shell 17 and the M20 finger upper shell 8, so that the clamping effect of the component in this part can be achieved. At the same time, an M20 vibration motor 18 is provided inside the M20 finger lower shell 17 and the M20 finger upper shell 8, which can also provide a vibration effect alone, and can also jointly achieve the vibration and clamping effects.

Cooperative use between the 130 gearbox motor 7, 030 vibration motor 9, N20 gearbox motor 15, M20 vibration motor 18, clamping structure, rocking member 14, and other structures enables conversion of rotational motion into clamping and rocking motions, achieving tapping, rocking, and vibration effects; clamping, rocking, and vibration can be controlled separately or work jointly via a PCBA board 21.

A left inner side of the plastic handle right shell 23 and plastic handle left shell 24 is provided with a PCBA board 21, a top of which is connected to a silicone button 20; a transparent cover 4 is provided on a top of the silicone button 20, and a digital display light shield 22 is provided on a top right side of the PCBA board 21.

A lower left corner inside the plastic handle right shell 23 and plastic handle left shell 24 is provided with a battery 5 and a magnetic charging pin board assembly 6 that are electrically connected.

### Embodiment 2

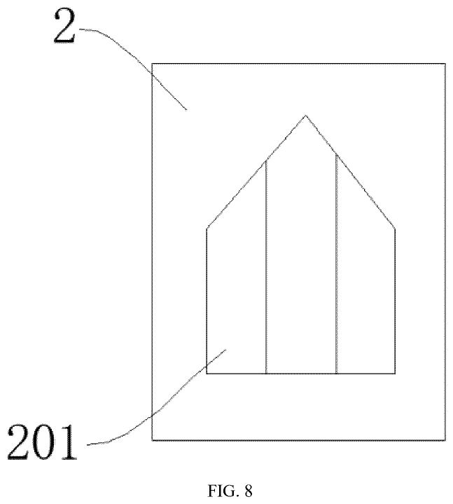

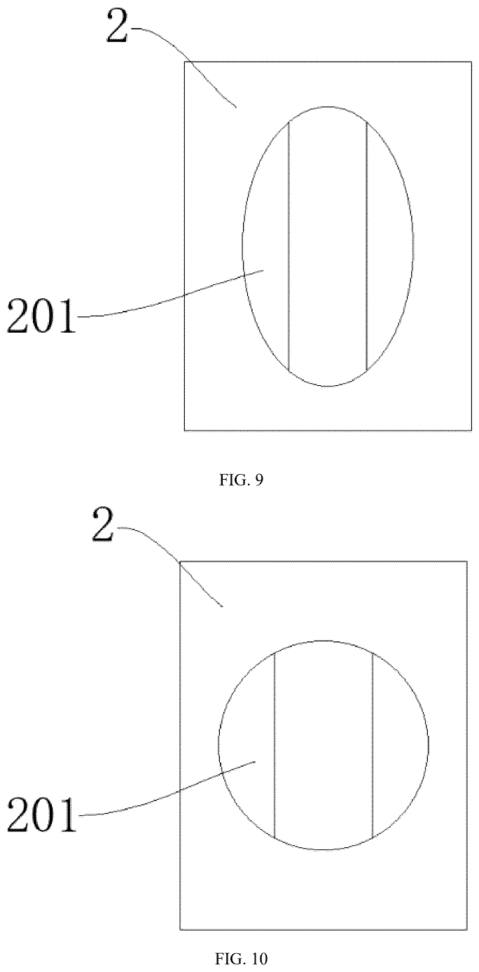

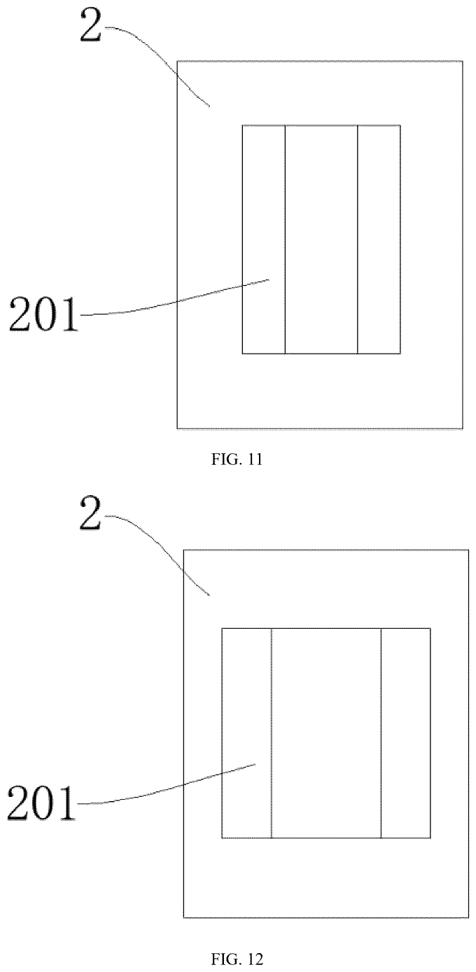

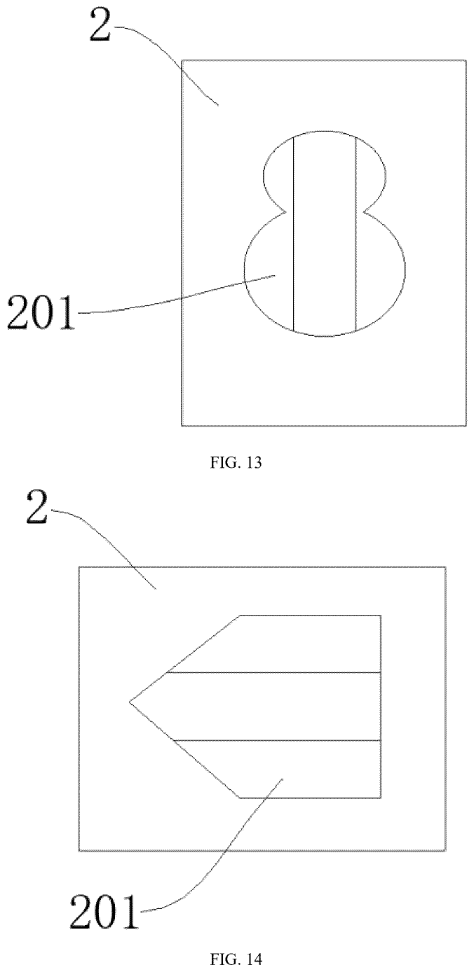

With reference to FIGS. 8-13, the invention provides a technical solution: the silicone body 2 is hollowed-out in an up-down direction; a shape of a hollowed-out groove 201 is one of polygon, ellipse, circle, rectangle, square, and gourd shape, including but not limited to; or a combination of at least any two of polygon, ellipse, circle, rectangle, square, and gourd shape.

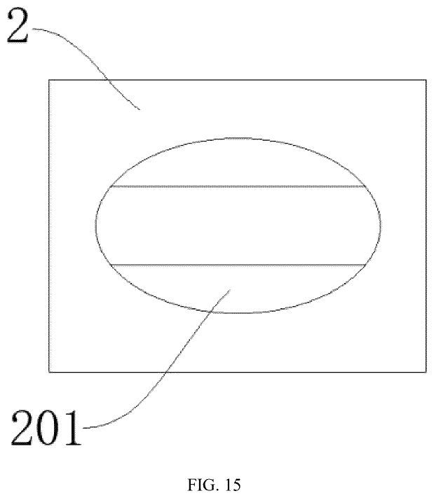

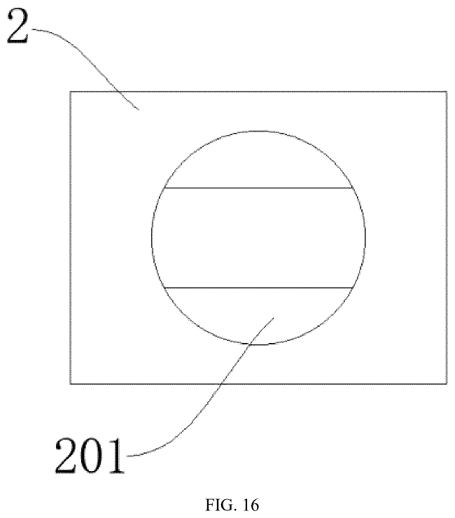

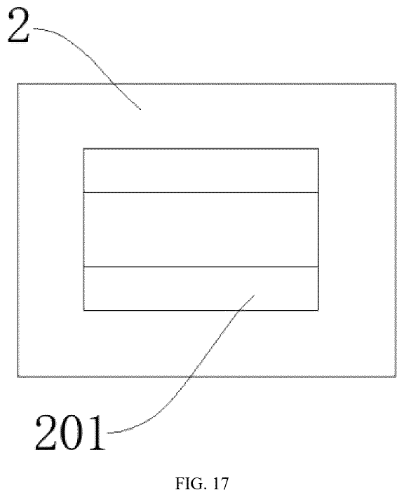

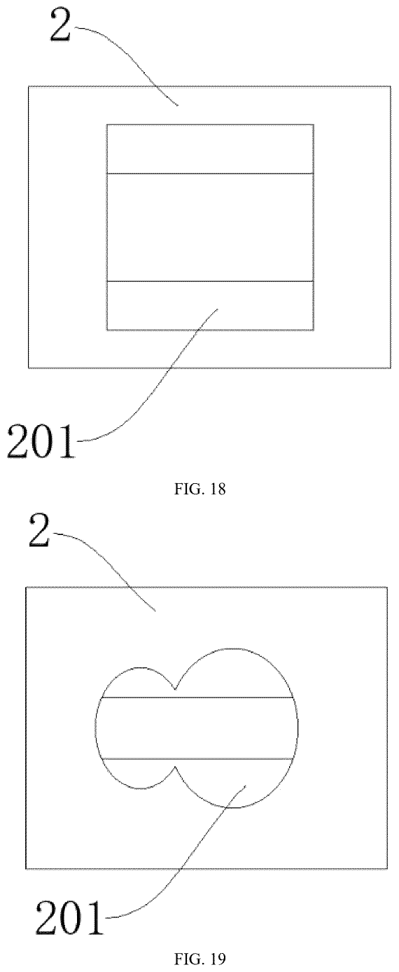

With reference to FIGS. 14-19, the invention provides a technical solution: the silicone body 2 is hollowed-out in a left-right direction; a shape of a hollowed-out groove 201 is one of polygon, ellipse, circle, rectangle, square, and gourd shape, including but not limited to; or a combination of at least any two of polygon, ellipse, circle, rectangle, square, and gourd shape.

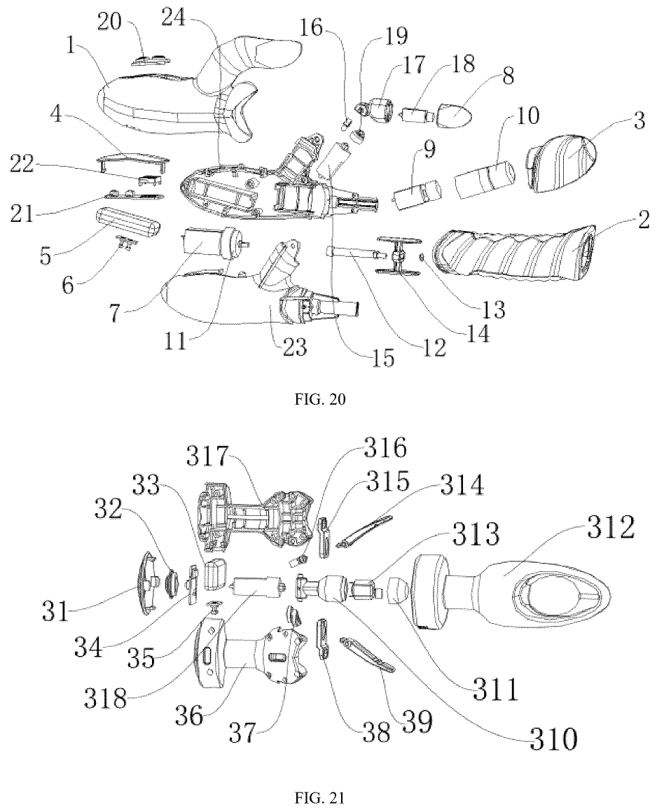

With reference to FIGS. 14-20, the invention provides a technical solution: the silicone body 2 is hollowed-out in up-down and left-right directions; a shape of a hollowed-out groove 201 is one of polygon, ellipse, circle, rectangle, square, and gourd shape, including but not limited to; or a combination of at least any two of polygon, ellipse, circle, rectangle, square, and gourd shape.

With reference to FIG. 21, a bilateral clamping assembly is installed at an inner top end of a silicone cover; an output end of a motor 18 is fixedly connected to a rotating block, a top side of the rotating block is fixedly connected to a hollow rod, and the hollow rod is fixedly connected to a swinging member; a pushing block is fixedly connected to a motor shell, and a motor 13 is installed inside the motor shell. Cooperative use between the motor 18, rotating block, pushing block, rocking member, motor shell, motor 13, and other structures transmutes rotary motion into oscillatory displacement, enabling dual-action clamping with or without synchronized vibration. These actions are independently or jointly controlled via a driver circuit.

### Embodiment 3

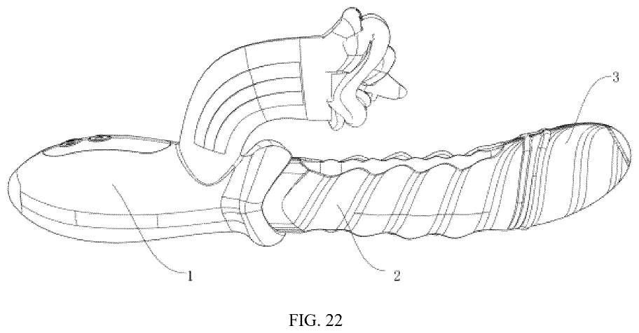

With reference to FIG. 22, the invention provides a technical solution: a hollowed-out massager, comprising a silicone handle 1, wherein a silicone body 2 is provided on the right side of the silicone handle 1, and a silicone head 3 is provided at one end of the silicone body 2 away from the silicone handle 1.

It should be noted that, in the specification, relational terms such as first and second, etc. are only used to distinguish one entity or operation from another entity or operation, and do not necessarily require or imply any such actual relationship or order between these entities or operations. Moreover, the terms “include”, “comprise” or any other variants thereof are intended to cover non-exclusive inclusion, so that a process, method, article or device including a series of elements includes not only those elements, but also other elements not explicitly listed, or also includes elements inherent to such process, method, article or device.

Although embodiments of the invention have been shown and described hereinabove, it should be understood by those skilled in the art that various changes, modifications, substitutions and variations may be made to the embodiments without departing from the principles and spirit of the invention, and that the scope of the invention is defined by the appended claims and the equivalents thereof.

1. A hollowed-out massager, comprising a silicone handle, wherein an interior of the silicone handle encloses a first plastic handle shell and a second plastic handle shell, and a silicone body is provided on a side of the first plastic handle shell and the second plastic handle shell; a 130 gearbox motor is provided inside the first plastic handle shell, the second plastic handle shell, and the silicone body, and a right side of the 130 gearbox motor is provided with an end cover; an output end of the 130 gearbox motor penetrates through the end cover and extends rightward, and is fixedly connected to an eccentric rod shaft; a rocking member is externally provided on a right side of the eccentric rod shaft, and a fixing member is fixedly connected to a right end of the eccentric rod shaft; the eccentric rod shaft, the fixing member, and the rocking member all rotate inside the silicone body.

2. The hollowed-out massager of claim 1, wherein the silicone body is hollowed-out on both top and bottom; a shape of a hollowed-out groove is one of polygon, ellipse, circle, rectangle, square, and gourd shape, including but not limited to; or a combination of at least any two of polygon, ellipse, circle, rectangle, square, and gourd shape.

3. The hollowed-out massager of claim 1, wherein the silicone body is hollowed-out on left and right sides; a shape of a hollowed-out groove is one of polygon, ellipse, circle, rectangle, square, and gourd shape, including but not limited to; or a combination of at least any two of polygon, ellipse, circle, rectangle, square, and gourd shape.

4. The hollowed-out massager of claim 1, wherein the silicone body is hollowed-out on top, bottom, left and right sides; a shape of a hollowed-out groove is one of polygon, ellipse, circle, rectangle, square, and gourd shape, including but not limited to; or a combination of at least any two of polygon, ellipse, circle, rectangle, square, and gourd shape.

5. The hollowed-out massager of claim 1, wherein a silicone head is provided on a right side of the silicone body, a 030 motor shell is provided inside the silicone head, and a 030 vibration motor is provided inside the 030 motor shell.

6. The hollowed-out massager of claim 5, wherein an upper inner side of the first plastic handle shell and the second plastic handle shell encloses an N20 gearbox motor; an output end of the N20 gearbox motor is fixedly connected to an eccentric wheel, and another end of the eccentric wheel is fixedly connected to a hollow rod; another end of the hollow rod is rotatably connected to an M20 finger lower shell, and a right side of the M20 finger lower shell is provided with an M20 finger upper shell, the M20 finger lower shell and the M20 finger upper shell together form a clamping structure; an M20 vibration motor is provided inside the M20 finger lower shell and M20 finger upper shell.

7. The hollowed-out massager of claim 6, wherein cooperative use between the 130 gearbox motor, 030 vibration motor, N20 gearbox motor, M20 vibration motor, clamping structure, and rocking member enables conversion of rotational motion into clamping and rocking motions, achieving clamping, rocking, and vibration effects; the clamping, rocking, and vibration can be controlled separately or work jointly via a PCBA.

8. The hollowed-out massager of claim 1, wherein a left inner side of the plastic handle right shell and plastic handle left shell is provided with a PCBA, a top of which is connected to a silicone button; a transparent cover is provided on a top of the silicone button, and a digital display light shield is provided on a top right side of the PCBA.

9. The hollowed-out massager of claim 1, wherein a lower left corner inside the first plastic handle shell and the second plastic handle shell is provided with a battery and a magnetic charging pin board assembly that are electrically connected.

10. The hollowed-out massager of claim 9, wherein a bilateral clamping assembly is installed at an inner top end of a silicone cover, the clamping assembly comprises a N30 gearbox motor, a rotating block, a hollow rod, two pushing blocks, two swinging members, and a N10 copper head motor; an output end of the N30 gearbox motor is fixedly connected to the rotating block, a top side of the rotating block is fixedly connected to the hollow rod, and the hollow rod is fixedly connected to the two pushing blocks, pushing blocks are fixedly connected to the swinging members respectively; the pushing blocks are fixedly connected to a motor shell, and the N10 copper head motor is installed inside the motor shell.
